(19) United States
(12) Patent Application Publication
(10) Pub. No.: US 2026/0024311 A1
(43) Pub. Date: Jan. 22, 2026

(54) IMAGE PROCESSING APPARATUS, IMAGE PROCESSING METHOD AND MAGNETIC RESONANCE IMAGING APPARATUS

(71) Applicant: CANON MEDICAL SYSTEMS CORPORATION, Otawara-shi (JP)

(72) Inventors: Zhenxi Zhang, Beijing (CN); Sha Wang, Beijing (CN); Lijun Zhang, Beijing (CN); Chunyao Wang, Beijing (CN)

(73) Assignee: CANON MEDICAL SYSTEMS CORPORATION, Otawara-shi (JP)

(21) Appl. No.: 19/273,241

(22) Filed: Jul. 18, 2025

(30) Foreign Application Priority Data
Jul. 19, 2024 (CN) 202410976806.8
Jun. 27, 2025 (JP) 2025-109282

(51) Int. Cl. G06V 10/764; G06V 10/74; G06V 10/762; G06V 10/82

(52) U.S. Cl. CPC G06V 10/764; G06V 10/761; G06V 10/762; G06V 10/82

(57) ABSTRACT

An image processing apparatus according to an embodiment includes processing circuitry. The processing circuitry acquires k-space data, classifies ACS data in the k-space data corresponding to each of a plurality of frames into a plurality of groups, generates a sensitivity map, performs an image space regularization process, and performs a data consistency process.

### CROSS-REFERENCE TO RELATED APPLICATIONS

This application is based upon and claims the benefit of priority from Chinese Patent Application No. 202410976806.8, filed on Jul. 19, 2024; and Japanese Patent Application No. 2025-109282, filed on Jun. 27, 2025, the entire contents of all of which are incorporated herein by reference.

### FIELD

Embodiments described herein relate generally to an image processing apparatus, an image processing method and magnetic resonance imaging apparatus.

### BACKGROUND

A magnetic resonance imaging technique is a non-invasive medical imaging technique using a magnetic resonance phenomenon in which a hydrogen nucleus placed in a static magnetic field resonates with a high-frequency magnetic field of a specific frequency. Dynamic magnetic resonance imaging is a type of magnetic resonance imaging technique, and can acquire magnetic resonance images in a time series, allowing observation and analysis of dynamic changes in an organ or tissue over a constant period of time.

In dynamic magnetic resonance imaging, a pulse signal is transmitted to a subject (patient) in a magnetic field that is frequency-encoded and phase-encoded, and echo signals due to specific nuclear magnetic resonance are received from a plurality of receiver coils, so that multiple temporally consecutive k-space frame data are acquired and magnetic resonance image time series data is reconstructed on the basis of k-space time series data including the k-space frame data.

However, a long-term magnetic resonance scan is required to acquire all of the k-space frame data, and in this case, the multiple magnetic resonance image frame data included in the reconstructed magnetic resonance image time series data are temporally discontinuous (interval becomes larger), making it not possible to accurately represent temporal changes in an object to be scanned. Therefore, in magnetic resonance imaging, some k-space frame data is usually acquired by undersampling, and magnetic resonance image time series data is reconstructed on the basis of k-space time series data including the undersampled k-space frame data, thereby reducing the magnetic resonance scan time.

Non-Patent Document 1 (k-t CLAIR: Self-Consistency Guided Multi-Print Learning for Dynamic Parallel MR Image Reconstruction, Lipping Zhang, & Weitian Chen.(2024).arXiv:2310.11050) discloses an image processing method for magnetic resonance image reconstruction using an end-to-end unrolled reconstruction network, which calculates sensitivity maps of a plurality of receiver coils via a neural network. The image processing method in Non-Patent Document 1 calculates a sensitivity map by using a convolutional neural network on the basis of an auto-calibration signal (ACS). Non-Patent Document 2 (Deep Cardiac MRI Reconstruction with ADMM, George Yiasemis, Nikita Moriaov, Jan-Jakob Sonke, & Jonas Teuwen.(2023).arXiv:2310.06628) discloses an image processing method for magnetic resonance image reconstruction using an end-to-end unrolled reconstruction network, which calculates sensitivity maps of a plurality of receiver coils via a neural network. In the image processing method of Non-Patent Document 2, a sensitivity map generated on the basis of ACS is improved (refined) with a 2D U-Net model.

### BRIEF DESCRIPTION OF THE DRAWINGS

FIG. 1 is a diagram illustrating an example of the configuration of a magnetic resonance image reconstruction apparatus according to an embodiment;

FIG. 2 is a flowchart showing the flow of a magnetic resonance image reconstruction method according to an embodiment;

FIG. 3 is a diagram illustrating an example of the configuration of k-space time series data and k-space frame data;

FIG. 4 is a data flow diagram for explaining processes of steps S102 to S106 of the magnetic resonance image reconstruction method according to an embodiment;

FIG. 5 is a data flow diagram for explaining a process of step S107 of the magnetic resonance image reconstruction method according to an embodiment;

FIG. 6 is a data flow diagram for explaining processes of steps S109 and S110 of the magnetic resonance image reconstruction method according to an embodiment;

FIG. 7 is a diagram for comparing a magnetic resonance image reconstructed using the magnetic resonance image reconstruction method with a magnetic resonance image reconstructed using the related art; and

FIG. 8 is a diagram illustrating problems of a magnetic resonance image reconstruction method in the related art.

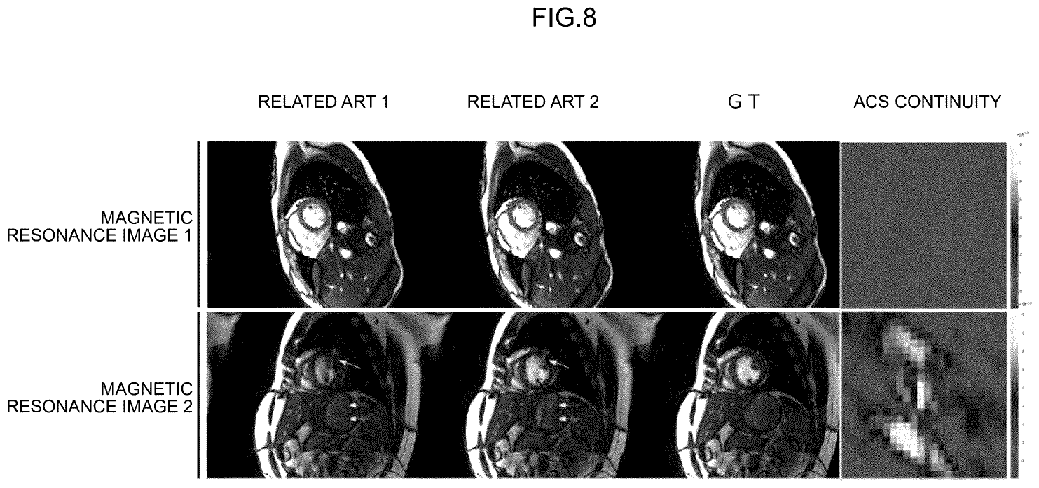

### DETAILED DESCRIPTION

An image processing apparatus provided in one aspect of the present invention includes processing circuitry. The processing circuitry acquires k-space data obtained by undersampling using a plurality of coils and corresponding to each of a plurality of frames, classifies ACS data in the k-space data corresponding to each of the plurality of frames into a plurality of groups, generates a sensitivity map corresponding to each of the plurality of coils on the basis of data based on ACS data classified into a first group included in the plurality of groups and data based on ACS data classified into a second group included in the plurality of groups, generates an image corresponding to a first frame of the plurality of frames on the basis of the sensitivity map and the k-space data corresponding to the first frame, generates an image corresponding to a second frame of the plurality of frames on the basis of the sensitivity map and the k-space data corresponding to the second frame, performs an image space regularization process on the image corresponding to the first frame, performs an image space regularization process on the image corresponding to the second frame, performs a data consistency process on the image corresponding to the first frame subjected to the image space regularization process, on the basis of the k-space data corresponding to the first frame and the sensitivity map, and performs a data consistency process on the image corresponding to the second frame subjected to the image space regularization process, on the basis of the k-space data corresponding to the second frame and the sensitivity map.

Embodiments of an image processing apparatus and an image processing method are described below in detail with reference to the drawings.

A magnetic resonance image reconstruction apparatus of the present embodiment is an image processing apparatus that reconstructs magnetic resonance image time series data in an image space on the basis of k-space time series data obtained by undersampling using a plurality of coils. The objective is to estimate the ground truth (GT) of the magnetic resonance image time series data corresponding to fully sampled k-space time series data and reconstruct magnetic resonance image time series data close to the GT of the magnetic resonance image time series data.

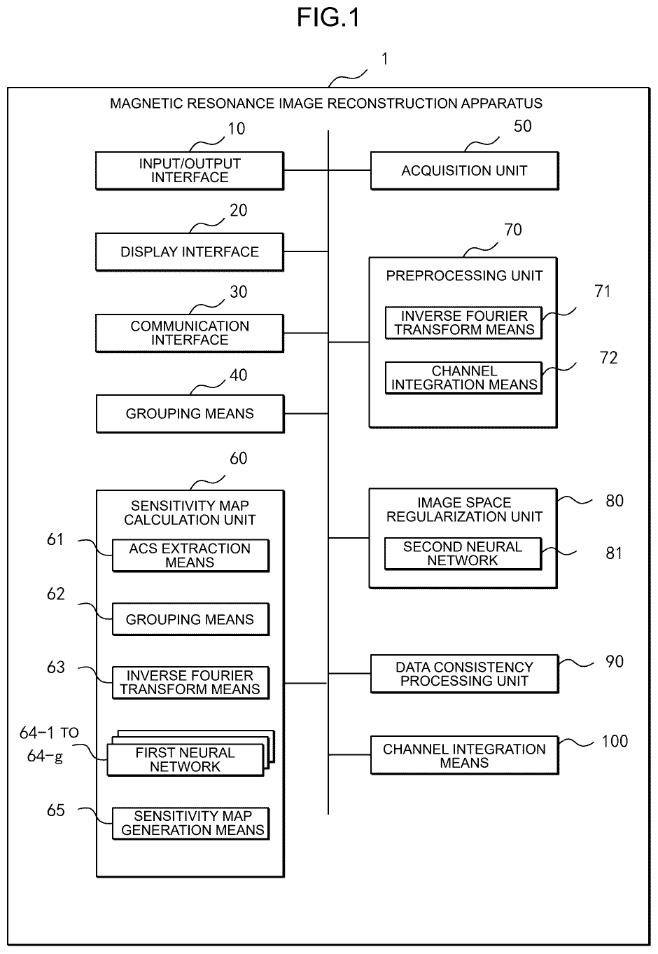

FIG. 1 is a diagram illustrating an example of the configuration of a magnetic resonance image reconstruction apparatus 1 according to an embodiment. With reference to FIG. 1, the configuration of the magnetic resonance image reconstruction apparatus 1 of the embodiment is described. The magnetic resonance image reconstruction apparatus 1 of the embodiment has an input/output interface 10, a display interface 20, a communication interface 30, a storage unit 40, an acquisition unit 50, a sensitivity map calculation unit 60, a preprocessing unit 70, an image space regularization unit 80, a data consistency processing unit 90, and an output unit 100. The input/output interface 10, the display interface 20, the communication interface 30, the storage unit 40, the acquisition unit 50, the sensitivity map calculation unit 60, the preprocessing unit 70, the image space regularization unit 80, the data consistency processing unit 90, and the output unit 100 are communicably connected to one another.

The input/output interface 10 is an interface for connecting the magnetic resonance image reconstruction apparatus 1 to input devices (not illustrated), receives user input operations from the input devices, and transmits signals based on the received input operations to the magnetic resonance image reconstruction apparatus 1. The input/output interface 10 is, for example, a serial bus interface such as a USB. The input devices include mice, keyboards, trackballs, switches, buttons, joysticks, touch screens, microphones, or the like. The input/output interface 10 may also be connected to a storage device and read/write various types of data to/from the storage device. The storage device is, for example, a hard disk drive (HDD), a solid state drive (SSD), or the like.

The display interface 20 is an interface for connecting the magnetic resonance image reconstruction apparatus 1 to a display device (not illustrated), transmits data to the display device, and causes the display device to display images. The display interface 20 is, for example, a video output interface such as a digital visual interface (DVI) or a high-definition multimedia interface (HDMI) (registered trademark). The display device includes a liquid crystal display (LCD), an electroluminescence (OLED) display, or the like. The display device displays a user interface for receiving input operations from a user, magnetic resonance image data output from the magnetic resonance image reconstruction apparatus 1, or the like, and the user interface is, for example, a graphical user interface (GUI) or the like.

The communication interface 30 is an interface for connecting the magnetic resonance image reconstruction apparatus 1 to a server (not illustrated), and can transmit and receive various types of data to/from a server. The communication interface 30 is, for example, a network card such as a wireless network card or a wired network card.

The storage unit 40 stores data such as image data and k-space data used for image reconstruction. The storage unit 40 also stores parameters used when the magnetic resonance image reconstruction apparatus 1 performs image reconstruction, for example, parameters of a neural network. The storage unit 40 also stores teacher data for training each neural network and other learnable parameters used by the magnetic resonance image reconstruction apparatus 1. The storage unit 40 is implemented by, for example, a storage device such as a read only memory (ROM), a flash memory, a random access memory (RAM), a hard disc drive (HDD), a solid state drive (SSD), and a register. The flash memory, the HDD, the SSD, and the like are nonvolatile storage media. These nonvolatile storage media may be implemented by other storage devices connected via a network, such as network attached storages (NAS) or external storage server devices. The above network includes, for example, the Internet, a wide area network (WAN), a local area network (LAN), a carrier terminal, a wireless communication network, a wireless base station, a leased line, and the like.

In the embodiment, respective processing functions performed by the sensitivity map calculation unit 60 (ACS extraction means 61, grouping means 62, inverse Fourier transform means 63, first neural networks 64-1 to 64-g, and sensitivity map generation means 65), the acquisition unit 50, the preprocessing unit 70 (inverse Fourier transform means 71 and channel integration means 72), the image space regularization unit 80 (second neural network 81), the data consistency processing unit 90, and the output unit 100 are stored in the storage unit 40 in the form of computer programs executable by a computer. These functions are implemented by processing circuitry that reads the computer programs from the storage unit 40 and executes the read computer programs, thereby implementing functions corresponding to the executed computer programs. In other words, the processing circuitry in the state of having read the computer programs has the functions illustrated in FIG. 1. In FIG. 1, these processing functions are described as being implemented by the single processing circuitry; however, the processing circuitry may be configured by combining a plurality of independent processors and respective processors may implement functions by executing computer programs. In other words, each of the above functions may be configured as a computer program, and one processing circuitry may execute each computer program. Another example may be a case where specific functions are implemented in dedicated and independent program execution circuitry. In FIG. 1, the grouping means 62, the preprocessing unit 70, and the data consistency processing unit are examples of a classification unit, an image generation unit, and a regularization unit, respectively.

The term “processor” used in the above description means, for example, circuitry such as a central processing unit (CPU), a graphical processing unit (GPU), an application specific integrated circuit (ASIC), or a programmable logic device (for example, a simple programmable logic device (SPLD), a complex programmable logic device (CPLD), and a field programmable gate array (FPGA)). The processor implements the functions by reading and executing the computer programs stored in the storage unit 40.

The acquisition unit 50 acquires k-space time series data obtained by undersampling using a plurality of coils. The undersampled k-space time series data includes multiple temporally consecutive undersampled k-space frame data. The undersampled k-space frame data represents k-space data collected by each receiver coil at a specific timing in a dynamic magnetic resonance imaging scan.

The sensitivity map calculation unit 60 generates sensitivity map time series data indicating the sensitivity of the plurality of receiver coils used in the dynamic magnetic resonance scan, on the basis of the undersampled k-space time series data.

The sensitivity map time series data includes multiple temporally consecutive sensitivity map frame data. The sensitivity map frame data indicates the sensitivity of each receiver coil for each scan position within a scan range at a specific timing in the dynamic magnetic resonance imaging scan.

The sensitivity map calculation unit 60 has the ACS extraction means 61, the grouping means 62, the inverse Fourier transform means 63, a plurality of the first neural networks 64-1 to 64-g, and the sensitivity map generation means 65.

The ACS extraction means 61 extracts ACS time series data from the k-space time series data. The ACS is used to correct phase and amplitude errors in k-space data due to magnetic field inhomogeneity, coil characteristics, or the like. The ACS is data located near the center of a k-space.

The grouping means 62 groups multiple ACS frame data included in the ACS time series data to generate ACS group data with a predetermined number g (g is an integer equal to or greater than 2) of groups.

The inverse Fourier transform means 63 performs an inverse Fourier transform on the ACS group data by using an algorithm, such as an inverse fast Fourier transform, to generate ACS image group data.

Each of the first neural networks 64-1 to 64-g performs image processing on the ACS image group data to generate image group data for sensitivity calculation for calculating the sensitivity map time series data. The plurality of first neural networks 64-1 to 64-g are, for example, convolutional neural networks, transformers, or the like.

The plurality of first neural networks 64-1 to 64-g are preferably convolutional neural networks. More preferably, the plurality of first neural networks 64-1 to 64-g are U-Nets. In the present embodiment, the plurality of first neural networks 64-1 to 64-g are each a convolutional neural network that includes an input layer, an output layer, a convolutional layer, an excitation layer, a pooling layer, a batch normalization layer, and a fully connected layer and in which the input layer and the output layer have equal sizes. The plurality of first neural networks 64-1 to 64-g implement an image processing function by loading neural network parameters stored in the storage unit 40 and dedicated to the plurality of first neural networks 64-1 to 64-g. The parameters of the plurality of first neural networks 64-1 to 64-g may be shared or may not be shared, and the plurality of first neural networks 64-1 to 64-g preferably share the parameters. The number of first neural networks is equal to the number of ACS group data generated by the grouping means 62.

The sensitivity map generation means 65 calculates the sensitivity map time series data on the basis of the image group data for sensitivity calculation.

The preprocessing unit 70 preprocesses the undersampled k-space time series data on the basis of the sensitivity map time series data to generate initial image time series data. The initial image time series data is image space time series data corresponding to the undersampled k-space time series data.

The preprocessing unit 70 has the inverse Fourier transform means 71 and the channel integration means 72. The inverse Fourier transform means 71 performs an inverse Fourier transform on the k-space time series data by using an algorithm such as an inverse fast Fourier transform. The channel integration means 72 integrates multi-channel data corresponding to each receiver coil in the image time series data into single-channel data on the basis of the sensitivity map time series data.

The image space regularization unit 80 performs an image space regularization process on the input image time series data in the image space by using the second neural network 81 to generate regularized image time series data that is the image time series data subjected to the regularization process. The image space regularization unit 80 has the second neural network 81. The second neural network 81 is, for example, a feedforward neural network, a convolutional neural network, a transformer, or the like. The second neural network 81 is preferably a convolutional neural network. More preferably, the second neural network 81 is a U-Net. In the present embodiment, the second neural network 81 is a convolutional neural network that includes an input layer, an output layer, a convolutional layer, an excitation layer, a pooling layer, a batch normalization layer, and a fully connected layer and in which the input layer and the output layer have equal sizes. The second neural network 81 implements the function of the image space regularization process by loading neural network parameters stored in the storage unit 40 and dedicated to the second neural network 81. By loading different neural network parameters, the second neural network 81 can be made to perform different regularization processes.

The data consistency processing unit 90 performs a data consistency process on the regularized image time series data on the basis of the undersampled k-space time series data and the sensitivity map time series data so that k-space time series data corresponding to the regularized image time series data approaches the undersampled k-space time series data, thereby generating corrected image time series data.

The output unit 100 outputs image time series data based on the corrected image time series data as reconstructed magnetic resonance image time series data.

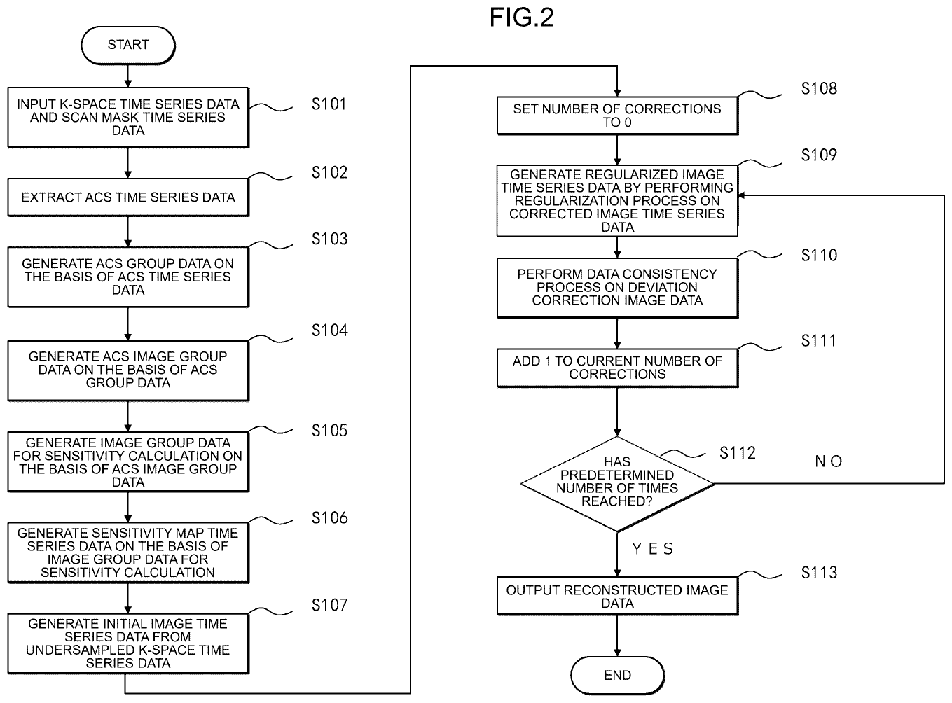

FIG. 2 is a flowchart showing the flow of a magnetic resonance image reconstruction method according to the embodiment. The flow of the magnetic resonance image reconstruction method according to the embodiment is described below with reference to FIG. 2.

The magnetic resonance image reconstruction method of the present embodiment is an image processing method for reconstructing image space magnetic resonance image time series data on the basis of k-space time series data obtained by undersampling using a plurality of coils.

First, the procedure proceeds to step S101. At step S101, the acquisition unit 50 acquires undersampled k-space time series data K₀ input from the storage unit 40 or an external storage device and scan mask time series data M corresponding to the undersampled k-space time series data K₀, and inputs the acquired data to the magnetic resonance image reconstruction apparatus 1. That is, the acquisition unit 50 acquires k-space data obtained by undersampling using a plurality of coils and corresponding to each of a plurality of frames.

The k-space time series data K₀ includes k-space frame data F₁ to F_{f} with the number f of frames. The number f of frames is the number of k-space frame data collected in a dynamic magnetic resonance scan. The k-space frame data F₁ to F_{f} indicate k-space data collected at a plurality of consecutive timings.

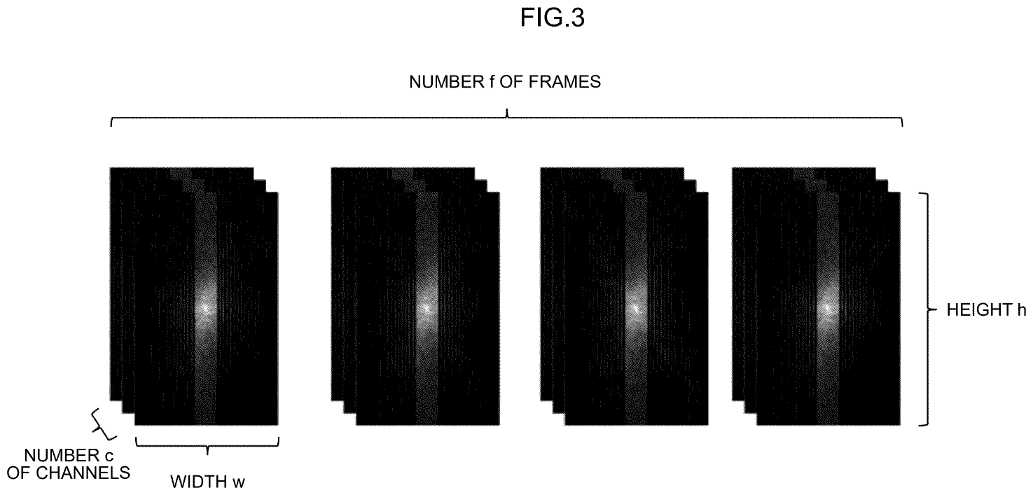

FIG. 3 is a diagram illustrating an example of the configuration of the k-space time series data K₀ and the k-space frame data F₁ to F_{f}. The k-space time series data K₀ and the k-space frame data F₁ to F_{f} of the present embodiment are described with reference to FIG. 3. As illustrated in FIG. 3, in the present embodiment, the k-space time series data K₀ is fourth-dimensional tensor data with width w×height h×number c of channels (number of receiver coils)×number f of frames. The k-space time series data K₀ includes the k-space frame data F₁ to F_{f} with the number f of frames, which is three-dimensional tensor data with width w×height h×number c of channels. Each of the k-space frame data F₁ to F_{f} includes two-dimensional matrix data with the number c of channels, which indicate k-space data received by each receiver coil.

Here, a width direction of the matrix is a phase-encoding direction and a height direction is a frequency-encoding direction. The dynamic magnetic resonance scan is undersampled with specific frequency and phase encodings omitted to reduce scan time, so magnetic resonance scans skip positions corresponding to specific frequency and phase encodings. As a result, in the k-space time series data K₀, no data exists at some positions corresponding to frequency codes and phase codes, and zero-filling is performed on data at those some positions. Since data near the center of the k-space data has a large impact on the contrast of the reconstructed image data, when undersampling is performed, data near the center in the frequency-encoding and phase-encoding directions is usually sampled at the center, and data at some positions far from the center are skipped.

The scan mask time series data M indicates which positions of the k-space time series data K₀ have been sampled or omitted in the magnetic resonance scan. The scan mask time series data M is a fourth-dimensional tensor of the same size as the k-space time series data K₀. The scan mask time series data M includes completely matched and two-dimensional matrix data of width w×height h with the number c of channels×the number f of frames. In these two-dimensional matrix data, the values of the frequency-encoded and phase-encoded positions subjected to sampling are set to 1, and the values of the frequency-encoded and phase-encoded positions subjected to no sampling are set to 0.

After the process of step S101 is completed, the procedure proceeds to step S102. At steps S102 to S106 (example of a sensitivity map calculation step), the sensitivity map calculation unit 60 generates sensitivity map time series data S indicating the sensitivity of a plurality of receiver coils used for the dynamic magnetic resonance scan, on the basis of the undersampled k-space time series data K₀.

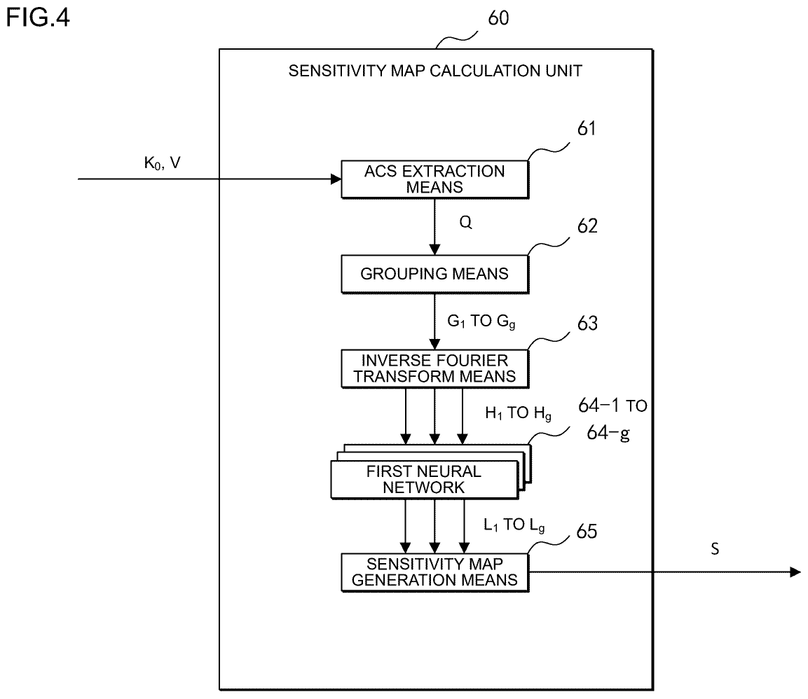

FIG. 4 is a data flow diagram for explaining processes of steps S102 and S106 of the magnetic resonance image reconstruction method according to the embodiment. In FIG. 4, the data flow is indicated by solid arrows. The processes of steps S102 to S106 are described below with reference to FIG. 4.

At step S102, the ACS extraction means 61 of the sensitivity map calculation unit 60 extracts ACS time series data Q from the k-space time series data K₀.

Specifically, the ACS extraction means 61 calculates the Adamar product (product of corresponding elements) of the k-space time series data K₀ and ACS mask time series data V read from the storage unit 40, and generates the ACS time series data Q. Both the ACS time series data Q and the ACS mask time series data V are fourth-dimensional tensors of the same size as the k-space time series data K₀. The ACS mask time series data V includes completely matched two-dimensional matrix data of width w×height h with the number c of channels×the number f of frames, and in these two-dimensional matrix data, the value of a position in a region where the ACS exists is set to 1 and the value of remaining positions is set to 0. The ACS time series data Q includes two-dimensional matrix data of width w×height h with the number c of channels×the number f of frames, and each two-dimensional matrix data indicates the ACS of each coil at each timing.

After the process of step S102 is completed, the procedure proceeds to step S103. At step S103, on the basis of the similarity between pieces of the ACS frame data with the number f of frames included in the ACS time series data Q, the grouping means 62 of the sensitivity map calculation unit 60 groups the ACS frame data to generate ACS group data G₁ to G_{g} with a predetermined number g of groups. That is, the grouping means 62 as a classification unit classifies the ACS time series data Q, which is the ACS data in the k-space data corresponding to each of the plurality of frames, into a plurality of groups.

As an example, on the basis of the similarity between the pieces of ACS data in the k-space data corresponding to each of the plurality of frames, the grouping means 62 as a classification unit classifies each of the ACS data in the k-space data corresponding to each of the plurality of frames into a plurality of groups. Specifically, first, the grouping means 62 as a classification unit performs clustering on the ACS frame data with the number f of frames on the basis of the similarity between the pieces of ACS frame data being the ACS data in the k-space data corresponding to each of the plurality of frames, thereby classifying each of the ACS data in the k-space data corresponding to each of the plurality of frames into a plurality of groups and dividing the ACS frame data into a predetermined number g of groups. Each group includes ACS frame data with the number r of frames in the group. However, the number r of frames in the group is the number f of frames/the number g of groups.

Subsequently, the grouping means 62 generates the ACS group data G₁ to G_{g} by joining, in the frame dimension, the ACS frame data with the number r of frames in the group within each group.

The grouping means 62 as a classification unit may perform grouping on the basis of at least one of the difference value of pixel values between multiple ACS frame data, a Frobenius norm, cosine similarity, and an Euclidean distance, thereby classifying each of the ACS data in the k-space data corresponding to each of the plurality of frames into a plurality of groups.

After the process of step S103 is completed, the procedure proceeds to step S104. At step S104, the inverse Fourier transform means 63 of the sensitivity map calculation unit 60 generates ACS image group data H₁ to H_{g} by performing inverse Fourier transform on the ACS group data G₁ to G_{g}. The ACS image group data H₁ to H_{g} are fourth-dimensional tensors of the same size as the ACS group data G₁ to G_{g}. The ACS image group data H₁ to H_{g} include two-dimensional image data, which is two-dimensional matrix data of width w×height h with the number c of channels×the number r of frames in the group, and each two-dimensional image data has hidden information on magnetic field inhomogeneity, coil sensitivity, or the like.

After the process of step S104 is completed, the procedure proceeds to step S105. At step S105, the sensitivity map calculation unit 60 performs image processing on each of the ACS image group data H₁ to H_{g} by each of the first neural networks 64-1 to 64-g to generate image group data L₁ to L_{g} for sensitivity calculation for calculating sensitivity map time series data S.

Each of the image group data L₁ to L_{g} for sensitivity calculation includes two-dimensional image data being two-dimensional matrix data of width w×height h with the number c of channels×the number r of frames in the group, and the two-dimensional image data with the number c of channels in each frame indicates the relative magnitude of sensitivity between receiver coils. Specifically, first, the sensitivity map calculation unit 60 reads the neural network parameters of the first neural networks 64-1 to 64-g from the storage unit 40 and loads the parameters into the first neural networks 64-1 to 64-g. Subsequently, the sensitivity map calculation unit 60 reads the ACS image group data H₁ to H_{g} from the storage unit 40, and inputs the ACS image group data H₁ to H_{g} to the first neural networks 64-1 to 64-g into which the parameters are loaded, respectively. Subsequently, each of the first neural networks 64-1 to 64-g performs forward propagation on the basis of each of the ACS image group data H₁ to H_{g}, and calculates the image group data L₁ to L_{g} for sensitivity calculation that is output data of the second neural network 81. The size of the image group data L₁ to L_{g} for sensitivity calculation is the same as the size of the ACS image group data H₁ to H_{g}.

After the process of step S105 is completed, the procedure proceeds to step S106. At step S106, the sensitivity map generation means 65 of the sensitivity map calculation unit 60 calculates the sensitivity map time series data S on the basis of the image group data L₁ to L_{g} for sensitivity calculation.

Specifically, first, the sensitivity map generation means 65 of the sensitivity map calculation unit 60 integrates image frame data for sensitivity calculation with the total number f of frames included in each of the image group data L₁ to L_{g} for sensitivity calculation, and generates image time series data for sensitivity calculation. In the above integration, the image frame data for sensitivity calculation with the total number f of frames included in the image group data L₁ to L_{g} for sensitivity calculation are rearranged so that the order of the frame data included in the image time series data for sensitivity calculation is the same as the order of the frame data in the k-space time series data K₀, and the image frame data for sensitivity calculation with the number f of frames are further joined in the frame dimension to generate image time series data for sensitivity calculation.

Subsequently, for each of the f pieces of image frame data for sensitivity calculation included in the image time series data for sensitivity calculation, the sensitivity map generation means 65 divides each pixel value in the image frame data for sensitivity calculation by the square root of the sum of squares of the pixel values of the number c of channels (including pixels itself) whose positions in the width direction and height direction are the same as the positions of the pixels. This results in the calculation of the sensitivity map time series data S. In this way, on the basis of data based on ACS data classified into a first group included in the plurality of groups and data based on ACS data classified into a second group included in the plurality of groups, the sensitivity map generation means 65 as a sensitivity map calculation unit generates a sensitivity map (sensitivity map time series data S) corresponding to each of the plurality of coils. For example, the sensitivity map calculation unit includes a first neural network that is a neural network corresponding to the first group and that generates image group data for sensitivity calculation for calculating the sensitivity map by performing image processing on the ACS data classified into the first group and a second neural network that is a neural network corresponding to the second group and that generates image group data for sensitivity calculation for calculating the sensitivity map by performing image processing on the ACS data classified into the second group, the image group data for sensitivity calculation is data indicating the relative magnitude of sensitivity between coils, and the sensitivity map generation means 65 as a sensitivity map calculation unit generates the sensitivity map on the basis of the image group data for sensitivity calculation generated by the first neural network and the image group data for sensitivity calculation generated by the second neural network. The first neural network and the second neural network may share parameters.

After the process of step S106 is completed, the procedure proceeds to step S107. At steps S102 to S106, the size of a model scale of the first neural network and the intensity of data sharing between the frame data can be adjusted by adjusting the size of the number g of groups. When the number g of groups is set small, the number r of frames in the group is large, the intensity of data sharing between frame data is large, and the model scale of the first neural network is large. This can improve the accuracy of the calculated sensitivity map time series data S, but increases the number of model parameters and increases the amount of calculation and training difficulty of the neural network. On the other hand, when the number g of groups is set large, the number r of frames in the group is small, the intensity of data sharing between frame data is small, and the model scale of the first neural network is small. This can reduce the number of model parameters and reduce the amount of calculation and training difficulty of the neural network, but the accuracy of the calculated sensitivity map time series data S is reduced accordingly.

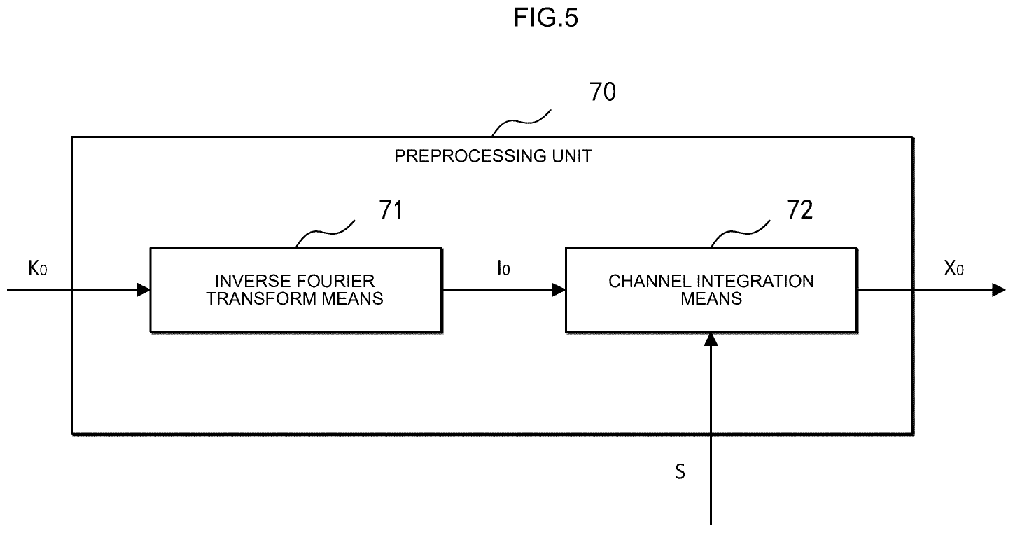

At step S107, the preprocessing unit 70 generates initial image time series data X₀ from the undersampled k-space time series data K₀. That is, the preprocessing unit 70 as an image generation unit generates, for example, an image corresponding to the first frame on the basis of the sensitivity map and k-spatial data corresponding to the first frame of the plurality of frames, and generates an image corresponding to the second frame on the basis of the sensitivity map and k-spatial data corresponding to the second frame of the plurality of frames. FIG. 5 is a data flow diagram for explaining the process of step S107 of the magnetic resonance image reconstruction method according to the embodiment. In FIG. 5, the data flow is indicated by solid arrows. The process of step S107 is described below with reference to FIG. 5.

First, the preprocessing unit 70 reads the k-space time series data K₀ from the storage unit 40, and performs an inverse Fourier transform on the k-space time series data K₀ by using the inverse Fourier transform means 71 to generate multi-channel image space time series data I₀. The multi-channel image space time series data I₀ is image space data of the same size as the k-space time series data K₀. The data of each channel of the multi-channel image space time series data I₀ is image space data transformed from k-space data collected by each receiver coil.

Subsequently, the preprocessing unit 70 generates the initial image time series data X₀ by integrating the data of a plurality of channels of the multi-channel image space time series data I₀ into single channel data on the basis the sensitivity map time series data S by means of the channel integration means 72. The initial image time series data X₀ is three-dimensional tensor data of width w×height h×number f of frames generated directly from the undersampled k-space time series data K₀, and includes two-dimensional image data, which is two-dimensional matrix data of width w×height h, with the number f of frames. The two-dimensional image data included in the initial image time series data X₀ has problems such as many artifacts and noise, lack of details, and blurred images.

After the process of step S107 is completed, the procedure proceeds to step S108. At steps S108 to S112, a correction process is repeated a predetermined number of times for the image data on the basis of the initial image time series data X₀. The predetermined number of times is preferably 8 to 10 times. Hereafter, image time series data that has been corrected t (t is an integer equal to or greater than 0) times on the basis of the initial image time series data X₀ is referred to as corrected image time series data Xₜ. The initial image time series data X₀ is the same image as the corrected image time series data X₀ when t is equal to 0.

At step S108, the magnetic resonance image reconstruction apparatus 1 sets the current number of corrections (iteration count) to 0. After the process of step S108 is completed, the procedure proceeds to step S109.

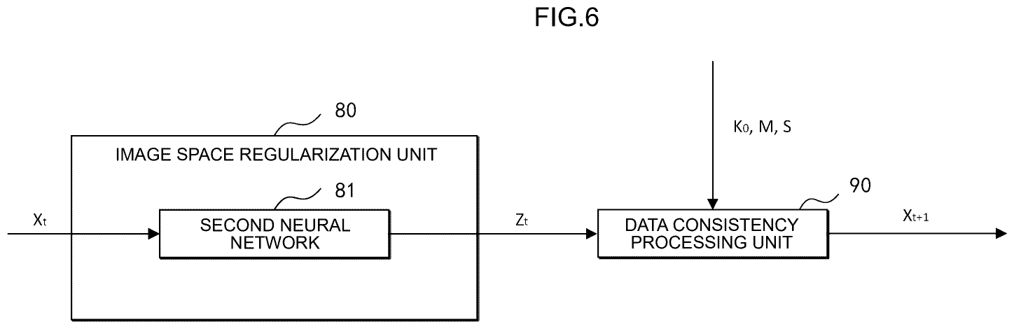

FIG. 6 is a data flow diagram for explaining processes of steps S109 and S110 of the magnetic resonance image reconstruction method according to the embodiment. In FIG. 6, the data flow is indicated by solid arrows. The processes of steps S109 and S110 are described below with reference to FIG. 6.

At step S109 (example of an image space regularization step), the image space regularization unit 80 generates regularized image time series data Zₜ by performing a regularization process on the corrected image time series data Xₜ in the image space by using the second neural network 81. Here, t is the current number of corrections. That is, the image space regularization unit 80 as a regularization unit performs an image space regularization process on the image corresponding to the first frame and performs an image space regularization process on the image corresponding to the second frame.

Specifically, the image space regularization unit 80 first reads the neural network parameters of the second neural network 81 corresponding to the current number of corrections from the storage unit 40, and loads the parameters into the second neural network 81. Subsequently, the image space regularization unit 80 reads the corrected image time series data Xₜ from the storage unit 40, and inputs the corrected image time series data Xₜ to the second neural network 81 with the parameters loaded. Subsequently, the image space regularization unit 80 calculates the regularized image time series data Zₜ, which is the output data of the second neural network 81, by causing the second neural network 81 to perform forward propagation on the basis of the corrected image time series data Xₜ. The regularized image time series data Zₜ is three-dimensional tensor data of the same size as the corrected image time series data Xₜ.

The process performed by the second neural network 81 is considered to be noise removal, artifact removal, and anti-aliasing for the corrected image time series data Xₜ. Accordingly, the regularized image time series data Zₜ is considered to be the corrected image time series data Xₜ subjected to the noise removal, artifact removal, and anti-aliasing.

The second neural network 81 preferably uses different neural network parameters for the correction process with different number of corrections. By causing the second neural network 81 to use different parameters at different correction stages, an appropriate process can be performed on the corrected image time series data Xₜ at different correction stages.

After the process of step S109 is completed, the procedure proceeds to step S110. At step S110 (example of a data consistency processing step), the data consistency processing unit 90 performs a data consistency process on the regularized image time series data Zₜ so that the k-space data corresponding to the regularized image time series data Zₜ approaches the undersampled k-space time series data K₀, thereby generating corrected image time series data Xₜ₊₁. That is, the data consistency processing unit 90 performs a data consistency process on the image corresponding to the first frame subjected to the image space regularization process on the basis of the k-space data corresponding to the first frame and the sensitivity map, and performs a data consistency process on the image corresponding to the second frame subjected to the image space regularization process on the basis of the k-space data corresponding to the second frame and the sensitivity map.

The data consistency processing unit 90 calculates the corrected image time series data Xₜ₊₁ by using the following Equation (1).

$${X}_{t + 1} = arg min λ {‖ A ( {X}_{t + 1} ) - {K}_{0} ‖}_{2}^{2} + {‖ {X}_{t + 1} - {Z}_{t} ‖}^{2} \qquad ( 1 )$$

In Equation (1) above, λ is a data consistency coefficient and A is a forward operator. λ may be a preset fixed value or a trainable value. An operation A(X) by the forward operator A for single-channel image data X means converting the image data X into multi-channel image data on the basis of the sensitivity map time series data S, acquiring the k-space data corresponding to the image data X by Fourier transforming the multi-channel image data, and then calculating the Adamar product of the acquired k-space data and the scan mask time series data M.

Equation (1) above can be solved by an optimization algorithm such as a gradient descent method or a proximal mapping method. The proximal mapping method can be further solved using a conjugate gradient method.

Pixel values of the corrected image time series data Xₜ₊₁ generated by the data consistency process are close to pixel values of the regularized image time series data Zₜ, but the k-space data corresponding to the corrected image time series data Xₜ₊₁ is closer to the undersampled k-space time series data K₀ than the k-space data corresponding to the regularized image time series data Zₜ.

After the process of step S110 is completed, the procedure proceeds to step S111. At step S111, 1 is added to the current number of corrections.

In the magnetic resonance image reconstruction method of the present embodiment, the processes of the steps S109 and S110 are used to perform the correction process on the corrected image time series data Xₜ once to generate the corrected image time series data Xₜ₊₁. The corrected image time series data Xₜ₊₁ is image data that is closer to the GT of the magnetic resonance image time series data than the corrected image time series data Xₜ.

After the process of step S111 is completed, the procedure proceeds to step S112. At step S112, it is determined whether the current number of corrections has reached a predetermined number of times. When it is determined that the predetermined number of times has been reached, the procedure proceeds to step S113, and when it is determined that the predetermined number of times has not been reached, the procedure proceeds to step S109.

At step S113, corrected image time series data that has been corrected the predetermined number of times is output as an estimated value of the GT of the magnetic resonance image time series data.

When the process of step S113 is completed, the procedure of the magnetic resonance image reconstruction method is terminated.

The effects of the magnetic resonance image reconstruction apparatus and the magnetic resonance image reconstruction method of the embodiment are described below.

The embodiment generates sensitivity map time series data showing the sensitivity of each receiver coil at each timing in a dynamic magnetic resonance imaging scan on the basis of ACS time series data included in undersampled k-space time series data. Therefore, even though the ACS is discontinuous, accurate sensitivity map time series data can be calculated and accurate correction can be made for magnetic field inhomogeneity and coil-to-coil mismatch, or the like. According to the embodiment, it is possible to suppress the reduction in the stability and accuracy of magnetic resonance image reconstruction due to ACS discontinuities.

In the embodiment, ACS frame data are grouped on the basis of the similarity between pieces of ACS frame data included in the ACS time series data to generate ACS group data, and sensitivity map time series data are calculated on the basis of the ACS group data. This can improve the accuracy of the calculated sensitivity map time series data and the accuracy of reconstructed magnetic resonance image time series data.

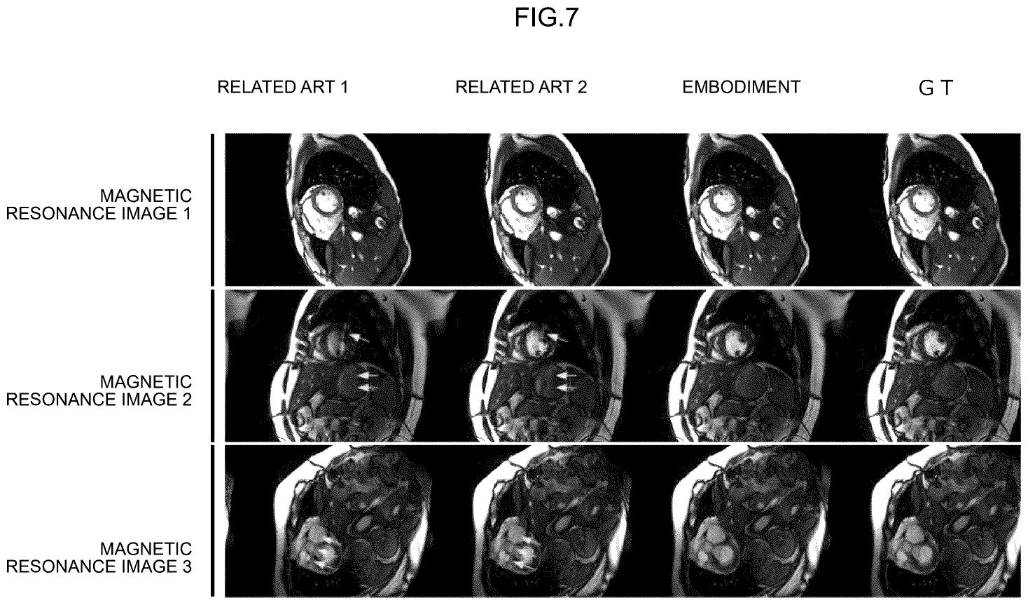

FIG. 7 is a diagram for comparing a magnetic resonance image reconstructed using the magnetic resonance image reconstruction method of the embodiment with a magnetic resonance image reconstructed using the related art.

In FIG. 7, the related art 1 is a technique for reconstructing magnetic resonance images by using a reconstruction network on the basis of an average ACS of multiple k-space frame data, and the related art 2 is a technique for reconstructing magnetic resonance images by using a reconstruction network on the basis of any ACS of multiple k-space frame data. In FIG. 7, magnetic resonance images 1 to 3 are reconstructed on the basis of k-space frame data included in different undersampled k-space time series data, respectively. In the reconstruction of the magnetic resonance images 2 and 3, ACSs of multiple k-space frame data in the k-space time series data are discontinuous.

As illustrated in FIG. 7, the magnetic resonance images 1 to 3 have been reconstructed by the magnetic resonance image reconstruction methods of the related arts 1 and 2 and the embodiment. The related arts 1 and 2 have generated significant artifacts (at the positions indicated by the arrows in the drawing) in the reconstruction for the magnetic resonance images 2 and 3. On the other hand, the magnetic resonance image reconstruction method of the embodiment has generated no artifacts in the reconstruction for the magnetic resonance images 1 to 3.

In the case of 4× and 8× undersampling, the magnetic resonance image reconstruction method of the embodiment has higher stability and accuracy of reconstruction than the related arts. In each test, compared to the magnetic resonance image reconstruction method in the related art, the magnetic resonance image reconstruction method of the embodiment has a higher structural similarity index (SSIM) and peak signal-to-noise Ratio (PSNR) and a lower normalized mean squared error (NMS).

### Method of Training and Evaluating Performance of Neural Network

In the above description, the magnetic resonance image reconstruction apparatus and the magnetic resonance image reconstruction method of the embodiment use the plurality of first neural networks 64-1 to 64-g, the second neural network 81, and the data consistency factor λ; however, these neural networks and parameters need to be pre-trained to operate properly. The above neural network and parameter training methods are described below.

First, a plurality of sets of pre-stored teacher data are read from the storage unit 40. Each set of teacher data includes the undersampled k-space time series data K₀ and the corresponding scan mask time series data M as input data, and the GT of the magnetic resonance image time series data as output data.

Subsequently, the plurality of sets of teacher data are divided into a training set, a test set, and a cross validation set. Examples of percentages for the training set, the test set and the cross validation set include 80%, 10%, and 10%, 90%, 5%, and 5%, and the like. For example, when the total number of teacher data is 10000 sets, the teacher data from data #1 to #10000 are divided as follows: data #1 to #8000 as the training set, data #8001 to #9000 as the test set, and data #9001 to #10000 as the cross validation set. In this case, input data for each set of teacher data in the training set is input to the magnetic resonance image reconstruction apparatus 1, and the magnetic resonance image reconstruction method of the present embodiment is performed to calculate an estimated value of magnetic resonance image time series data, to calculate a difference value between the estimated value of the magnetic resonance image time series data and the GT of the magnetic resonance image time series data, and to perform backpropagation on the basis of the difference value. This changes parameters of each neural network and other machine-learnable parameters so that the difference value between the estimated value of the magnetic resonance image time series data output by the magnetic resonance image reconstruction apparatus 1 and the GT of the magnetic resonance image time series data is reduced. For the majority of the data in the test set, the above procedure is repeated until the difference value between the estimated value of the magnetic resonance image time series data output by the magnetic resonance image reconstruction apparatus 1 and the GT of the magnetic resonance image time series data is smaller than a preset threshold value. Subsequently, training of each neural network and the parameters is determined to be complete.

Subsequently, input data of the cross validation data (data #9001 to #10000) is input to the learned magnetic resonance image reconstruction apparatus 1, and the peak signal-to-noise ratio of the estimated value of the magnetic resonance image time series data output by the magnetic resonance image reconstruction apparatus 1, a structural similarity index between the estimated value and the GT of the magnetic resonance image time series data, and a normalized mean square error are calculated as evaluation data.

According to at least one embodiment described above, image quality can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising processing circuitry configured to
acquire k-space data obtained by undersampling using a plurality of coils and corresponding to each of a plurality of frames,
classify ACS data in the k-space data corresponding to each of the plurality of frames into a plurality of groups,
generate a sensitivity map corresponding to each of the plurality of coils on the basis of data based on ACS data classified into a first group included in the plurality of groups and data based on ACS data classified into a second group included in the plurality of groups,
generate an image corresponding to a first frame of the plurality of frames on the basis of the sensitivity map and the k-space data corresponding to the first frame,
generate an image corresponding to a second frame of the plurality of frames on the basis of the sensitivity map and the k-space data corresponding to the second frame,
perform an image space regularization process on the image corresponding to the first frame,
perform an image space regularization process on the image corresponding to the second frame,
perform a data consistency process on the image corresponding to the first frame subjected to the image space regularization process, on a basis of the k-space data corresponding to the first frame and the sensitivity map, and
perform a data consistency process on the image corresponding to the second frame subjected to the image space regularization process, on a basis of the k-space data corresponding to the second frame and the sensitivity map.

2. The image processing apparatus according to claim 1, wherein on a basis of similarity between pieces of the ACS data in the k-space data corresponding to each of the plurality of frames, the processing circuitry classifies each of the ACS data in the k-space data corresponding to each of the plurality of frames into the plurality of groups.

3. The image processing apparatus according to claim 2, wherein on a basis of at least one of a difference value of pixel values between the pieces of the ACS data in the k-space data corresponding to each of the plurality of frames, a Frobenius norm, cosine similarity, and an Euclidean distance, the processing circuitry classifies each of the ACS data in the k-space data corresponding to each of the plurality of frames into the plurality of groups.

4. The image processing apparatus according to claim 1, wherein the processing circuitry classifies each of the ACS data in the k-space data corresponding to each of the plurality of frames into the plurality of groups by performing clustering on the ACS data in the k-space data corresponding to each of the plurality of frames.

5. The image processing apparatus according to claim 1, wherein
the processing circuitry includes a first neural network that is a neural network corresponding to the first group and that generates image group data for sensitivity calculation for calculating the sensitivity map by performing image processing on the ACS data classified into the first group, and a second neural network that is a neural network corresponding to the second group and that generates image group data for sensitivity calculation for calculating the sensitivity map by performing image processing on the ACS data classified into the second group,
the image group data for sensitivity calculation is data indicating a relative magnitude of sensitivity between the coils, and
the processing circuitry generates the sensitivity map on a basis of the image group data for sensitivity calculation generated by the first neural network and the image group data for sensitivity calculation generated by the second neural network.

6. The image processing apparatus according to claim 5, wherein the first neural network and the second neural network share parameters.

7. An image processing method comprising:
acquiring k-space data obtained by undersampling using a plurality of coils and corresponding to each of a plurality of frames,
classifying ACS data in the k-space data corresponding to each of the plurality of frames into a plurality of groups,
generating a sensitivity map corresponding to each of the plurality of coils on the basis of data based on ACS data classified into a first group included in the plurality of groups and data based on ACS data classified into a second group included in the plurality of groups,
generating an image corresponding to a first frame of the plurality of frames on the basis of the sensitivity map and the k-space data corresponding to the first frame,
generating an image corresponding to a second frame of the plurality of frames on the basis of the sensitivity map and the k-space data corresponding to the second frame,
performing an image space regularization process on the image corresponding to the first frame,
performing an image space regularization process on the image corresponding to the second frame,
performing a data consistency process on the image corresponding to the first frame subjected to the image space regularization process, on a basis of the k-space data corresponding to the first frame and the sensitivity map, and
performing a data consistency process on the image corresponding to the second frame subjected to the image space regularization process, on a basis of the k-space data corresponding to the second frame and the sensitivity map.

8. A magnetic resonance imaging apparatus comprising processing circuitry configured to
acquire k-space data obtained by undersampling using a plurality of coils and corresponding to each of a plurality of frames,
classify ACS data in the k-space data corresponding to each of the plurality of frames into a plurality of groups,
generate a sensitivity map corresponding to each of the plurality of coils on the basis of data based on ACS data classified into a first group included in the plurality of groups and data based on ACS data classified into a second group included in the plurality of groups,
generate an image corresponding to a first frame of the plurality of frames on the basis of the sensitivity map and the k-space data corresponding to the first frame,
generate an image corresponding to a second frame of the plurality of frames on the basis of the sensitivity map and the k-space data corresponding to the second frame,
perform an image space regularization process on the image corresponding to the first frame,
perform an image space regularization process on the image corresponding to the second frame,
perform a data consistency process on the image corresponding to the first frame subjected to the image space regularization process, on a basis of the k-space data corresponding to the first frame and the sensitivity map, and
perform a data consistency process on the image corresponding to the second frame subjected to the image space regularization process, on a basis of the k-space data corresponding to the second frame and the sensitivity map.
